(19) United States
(12) Patent Application Publication
(10) Pub. No.: US 2009/0089049 A1
(43) Pub. Date: Apr. 2, 2009

(54) METHOD AND APPARATUS FOR ADAPTIVELY DETERMINING QUANTIZATION STEP ACCORDING TO MASKING EFFECT IN PSYCHOACOUSTICS MODEL AND ENCODING/DECODING AUDIO SIGNAL BY USING DETERMINED QUANTIZATION STEP

(75) Inventors: Han-gil MOON, Seoul (KR); Geon-hyoung LEE, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/237,413

(22) Filed: Sep. 25, 2008

(30) Foreign Application Priority Data
Sep. 28, 2007 (KR) 10-2007-0098357

(51) Int. Cl. G10L 19/00

(52) U.S. Cl. 704/200.1; 704/E19.001

(57) ABSTRACT

Provided are a method of adaptively determining a quantization step according to a masking effect in a psychoacoustics model and a method of encoding/decoding an audio signal by using the determined quantization step. The method of adaptively determining a quantization step includes calculating a first ratio value indicating an intensity of an input audio signal with respect to a masking threshold; and determining the maximum value of the quantization step in a range in which noise generated when the audio signal is quantized is masked, according to the first ratio value. According to the present invention, quantization noise may be removed and the number of bits required to encode an audio signal may be reduced, by using auditory characteristics of humans.

### CROSS-REFERENCE TO RELATED PATENT APPLICATION

This application claims the benefit of Korean Patent Application No. 10-2007-0098357, filed on Sep. 28, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to adaptively determining a quantization step according to a masking effect in a psychoacoustics model and encoding/decoding an audio signal by using a determined quantization step, and more particularly, to a method and apparatus for determining the maximum value of a quantization step in a range in which noise generated when an audio signal is quantized is masked, and encoding/decoding the audio signal by using the determined maximum quantization step.

2. Description of the Related Art

Generally, when data is compressed, results of accessing the data before and after the data is compressed are required to be the same. However, if the data is in the form of audio or image signals which depend on perceptual abilities of humans, the data is allowed to include only human-perceptible data after being is compressed. Due to the above-described characteristic, when an audio signal is encoded, a lossy compression method is widely used.

When an audio signal is encoded using a lossy compression method, quantization is required. Here, the quantization is performed by dividing actual values of the audio signal into a plurality of segments according to a predetermined quantization step. A representative value is assigned to each segment in order to represent the segment. That is, the quantization is performed by representing the size of waveforms of the audio signal using a plurality of quantization levels of a previously determined quantization step. Here, in order to efficiently perform the quantization, determining the quantization step size is regarded as being important.

If the quantization step is too large, quantization noise generated by performing the quantization increases and thus the quality of the audio signal greatly deteriorates. On the other hand, if the quantization step is too small, the quantization noise decreases; however, the number of segments of the audio signal which are to be represented after the quantization is performed increases and thus a bit-rate required to encode the audio signal increases.

Therefore, a maximum quantization step is required to be determined for highly efficient encoding of an audio signal in order to reduce a bit-rate and to prevent sound quality from deteriorating due to quantization noise.

In particular, in a psychoacoustics model, a compression rate may be increased by removing inaudible portions using auditory characteristics of humans. This type of coding method is referred to as a perceptual coding method.

A representative example of human auditory characteristics used in perceptual coding is a masking effect. The masking effect is, briefly, a phenomenon that a small sound is masked and not heard due to a big sound if the big and small sounds are generated at the same time. The masking effect increases as the difference of volumes between the big sound (referred to as a masker) and the small sound (referred to as a maskee) is large and frequencies of the masker and maskee are similar. Furthermore, even if the big and small sounds are not generated at the same time, if the small sound is generated soon after the big sound is generated, the small sound may be masked.

FIG. 1 is a graph for describing a signal-to-noise ratio (SNR), a signal-to-mask ratio (SMR), and a noise-to-mask ratio (NMR) according to a masking effect.

Referring to FIG. 1, a masking curve of when a masking tone component exists is illustrated. This masking curve is referred to as a spread function. A sound below a masking threshold is masked by the masking tone component. The masking effect occurs almost uniformly in a critical band.

Here, the SNR, a ratio of the signal power to the noise power, is a sound pressure level (decibel: dB) at which a signal power exceeds a noise power. Generally, an audio signal does not exist by itself and exists together with noise. The SNR is used as a measure representing distributions of the signal and noise powers. The SMR, a ratio of the signal power to the masking threshold, represents the difference between the signal power and the masking threshold. The masking threshold is determined according to a minimum masking threshold in the critical band. The NMR represents a margin between the SNR and SMR.

For example, if the number of bits allocated to represent an audio signal is ‘m’ as illustrated in FIG. 1, correlations among the SNR, SMR, and NMR are illustrated by using arrows in FIG. 1.

Here, if a quantization step is set to be small, the number of bits required to encode the audio signal increases. For example, if the number of bits increases to ‘m+1’, the SNR also increases. On the other hand, if the number of bits decreases to ‘m−1’, the SNR also decreases. If the number of bits further decreases and the SNR is less than the SMR, the NMR is greater than the masking threshold. Thus, quantization noise of the audio signal is not masked and can be heard by humans.

That is, perceptually sensible sound quality according to auditory characteristics of humans may be different from a numerical value of the SNR. Accordingly, by using the above-described fact, even if a lower number of bits than a numerically required number of bits is used, subjective sound quality may be ensured.

FIG. 2 is a graph for describing correlations between a SNR and a SMR that is temporally variable, when quantization steps of 1 dB and 4 dB are applied.

When an audio signal is represented in temporal frames, values of the SMR temporally vary as illustrated in FIG. 2. In this case, a SNR 210 and a SNR 220 to which fixed quantization steps 4 dB and 1 dB are respectively applied are illustrated in FIG. 2.

First, if the quantization step of 1 dB is applied to the SNR 220, values of the SNR 220 are always greater than the values of the SMR in entire frames and thus quantization noise is removed. However, relative bit-rates increase. That is, SNR margins corresponding to differences between the SNR 220 and the SMR are generated and thus bits are unnecessarily wasted.

Then, if the quantization step of 4 dB is applied to the SNR 210, values of the SNR 210 are sometimes greater and sometimes less than the values of the SMR. For example, a SNR lack phenomenon occurs in circular regions 200a and 200b, illustrated using dotted lines in FIG. 2, because values of the SNR 210 are less than the values of the SMR. In this case, the quantization noise may not be sufficiently removed.

Conventional technologies select and use only one or more fixed quantization steps and thus SNR values may be unnecessarily wasted or may be insufficient.

### SUMMARY OF THE INVENTION

The present invention provides a method and apparatus for determining the maximum value of a quantization step in a range in which noise generated when an audio signal is quantized is masked, and encoding/decoding the audio signal by using the determined maximum quantization step.

According to an aspect of the present invention, there is provided a method of adaptively determining a quantization step according to a masking effect in a psychoacoustics model, the method including calculating a first ratio value indicating an intensity of an input audio signal with respect to a masking threshold; and determining the maximum value of the quantization step in a range in which noise generated when the audio signal is quantized is masked, according to the first ratio value.

The determining of the quantization step may include calculating a second ratio value which is greater than or equal to the first ratio value and indicates an intensity of the input audio signal with respect to the noise; and calculating the maximum value of the quantization step value according to the minimum value of the second ratio value.

The second ratio value may decrease as the quantization step increases.

The quantization step may be represented by a common logarithm including the first ratio value as an exponent.

The calculating of the first ratio value may include calculating masking thresholds of tone and noise components of the audio signal; and assigning weights to the calculated masking thresholds.

According to another aspect of the present invention, there is provided a method of encoding an audio signal by using a quantization step adaptively determined according to a masking effect in a psychoacoustics model, the method including calculating a first ratio value indicating an intensity of the audio signal with respect to a masking threshold; determining the maximum value of the quantization step in a range in which noise generated when the audio signal is quantized is masked, according to the first ratio value; quantizing the audio signal by using the determined quantization step; and generating a variable length encoded bitstream by using the quantized audio signal.

The calculating of the first ratio value may include calculating masking thresholds of tone and noise components of a previous frame of the audio signal to be encoded; and assigning weights to the calculated masking thresholds.

The determining of the maximum value of the quantization step may include calculating a second ratio value which is greater than or equal to the first ratio value and indicates an intensity of the input audio signal with respect to the noise; and calculating the maximum value of the quantization step according to the minimum value of the second ratio value.

The second ratio value may decrease as the quantization step increases.

The quantization step may be represented by a common logarithm including the first ratio value as an exponent.

According to another aspect of the present invention, there is provided a method of decoding an audio signal by using a dequantization step adaptively determined according to a masking effect in a psychoacoustics model, the method including variable length decoding the audio signal input in the form of a bitstream; calculating a first ratio value indicating an intensity of the variable length decoded audio signal with respect to a masking threshold; determining the maximum value of the dequantization step in a range in which noise generated when the audio signal is quantized is masked, according to the first ratio value; and dequantizing the audio signal by using the determined dequantization step.

The calculating of the first ratio value may include calculating masking thresholds of tone and noise components of a previous frame of the audio signal to be decoded; and assigning weights to the calculated masking thresholds.

The determining of the maximum value of the dequantization step may include calculating a second ratio value which is greater than or equal to the first ratio value and indicates an intensity of the input audio signal with respect to the noise; and calculating the maximum value of the dequantization step according to the minimum value of the second ratio value.

The second ratio value may decrease as the dequantization step increases.

The dequantization step may be represented by a common logarithm including the first ratio value as an exponent.

According to another aspect of the present invention, there is provided an apparatus for encoding an audio signal by using a quantization step adaptively determined according to a masking effect in a psychoacoustics model, the apparatus including a first ratio value calculation unit for calculating a first ratio value indicating an intensity of the audio signal with respect to a masking threshold; a quantization step determination unit for determining the maximum value of the quantization step in a range in which noise generated when the audio signal is quantized is masked, according to the first ratio value; a quantization unit for quantizing the audio signal by using the determined maximum value of the quantization step; and a variable length encoding unit for generating a variable length encoded bitstream by using the quantized audio signal.

The first ratio value calculation unit may include a threshold calculation unit for calculating masking thresholds of tone and noise components of a previous frame of the audio signal to be encoded; and a weight processing unit for assigning weights to the calculated masking thresholds. The quantization step determination unit may include a second ratio value calculation unit for calculating a second ratio value which is greater than or equal to the first ratio value and indicates an intensity of the input audio signal with respect to the noise; and a quantization step calculation unit for calculating the maximum value of the quantization step according to the minimum value of the second ratio value.

According to another aspect of the present invention, there is provided an apparatus for decoding an audio signal by using a dequantization step adaptively determined according to a masking effect in a psychoacoustics model, the apparatus include a variable length decoding unit for variable length decoding the audio signal input in the form of a bitstream; a first ratio value calculation unit for calculating a first ratio value indicating an intensity of the variable length decoded audio signal with respect to a masking threshold; a dequantization step determination unit for determining the maximum value of the dequantization step in a range in which noise generated when the audio signal is quantized is masked, according to the first ratio value; and a dequantization unit for dequantizing the audio signal by using the determined maximum value of the dequantization step.

The first ratio value calculation unit may include a threshold calculation unit for calculating masking thresholds of tone and noise components of a previous frame of the audio signal to be decoded; and a weight processing unit for assigning weights to the calculated masking thresholds. The dequantization step determination unit may include a second ratio value calculation unit for calculating a second ratio value which is greater than or equal to the first ratio value and indicates an intensity of the input audio signal with respect to the noise; and a dequantization step calculation unit for calculating the maximum value of the dequantization step according to the minimum value of the second ratio value.

### BRIEF DESCRIPTION OF THE DRAWINGS

The above and other features of the present invention will become more apparent by describing in detail exemplary embodiments thereof with reference to the attached drawings in which:

FIG. 1 is a graph for describing a signal-to-noise ratio (SNR), a signal-to-mask ratio (SMR), and a noise-to-mask ratio (NMR) according to a masking effect;

FIG. 2 is a graph for describing correlations between a SNR and a SMR that is temporally variable, when quantization steps of 1 dB and 4 dB are applied;

FIG. 3 is a flowchart illustrating a method of adaptively determining a quantization step according to a masking effect in a psychoacoustics model, according to an embodiment of the present invention;

FIGS. 4A and 4B are graphs for describing masking thresholds of tone and noise components of an audio signal, according to an embodiment of the present invention;

FIG. 5 is a graph for describing an adaptive quantization step that is temporally variable, according to an embodiment of the present invention;

FIG. 6 is a graph for describing correlations between a SNR and a SMR that is temporally variable, when an adaptive quantization step is applied, according to an embodiment of the present invention;

FIG. 7 is a flowchart illustrating a method of encoding an audio signal by using a quantization step adaptively determined according to a masking effect in a psychoacoustics model, according to an embodiment of the present invention;

FIG. 8 is a flowchart illustrating a method of decoding an audio signal by using a dequantization step adaptively determined according to a masking effect in a psychoacoustics model, according to an embodiment of the present invention;

FIG. 9 is a block diagram of an apparatus for encoding an audio signal by using a quantization step adaptively determined according to a masking effect in a psychoacoustics model, according to an embodiment of the present invention; and

FIG. 10 is a block diagram of an apparatus for decoding an audio signal by using a dequantization step adaptively determined according to a masking effect in a psychoacoustics model, according to an embodiment of the present invention.

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described in detail by explaining embodiments of the invention with reference to the attached drawings.

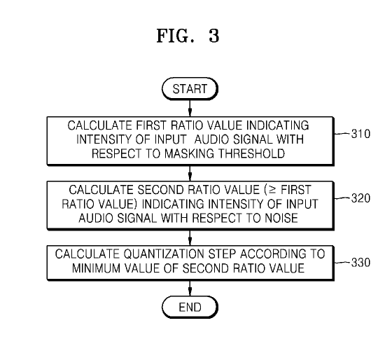

FIG. 3 is a flowchart illustrating a method of adaptively determining a quantization step according to a masking effect in a psychoacoustics model, according to an embodiment of the present invention.

Referring to FIG. 3, a first ratio value indicating an intensity of an input audio signal with respect to a masking threshold is calculated in operation 310.

Then, the maximum quantization step value in a range in which noise generated when the audio signal is quantized, is masked, is determined according to the first ratio value. In more detail, the determining of the quantization step is performed by calculating a second ratio value which is greater than or equal to the first ratio value and indicates an intensity of the input audio signal with respect to the noise in operation 320, and calculating the minimum quantization step value according to the second ratio value in operation 330.

In operation 310, a signal-to-mask ratio (SMR) may be used as the first ratio value indicating the intensity of the input audio signal with respect to the masking threshold. The SMR may be calculated by calculating masking thresholds of tone and noise components of the audio signal and assigning weights to the calculated masking thresholds.

In operation 320, a signal-to-noise ratio (SNR) that is greater than or equal to the SMR is calculated as the second ratio value that indicates the intensity of the input audio signal with respect to the noise.

For example, if a signal value is a=10x/20, assuming that the quantization step is Δ, a+Δ/2=10(x+step/2)/20. The SNR may be represented by SNR=20 log 10 [signal value/maximum noise], as a decibel value. A certain value in the quantization step is rounded and thus the maximum noise is fixed to be ±½ of the quantization step. Accordingly, the SNR may be represented as in EQN. 1.

$$S N R = 20 {log}_{10} [ \frac{{10}^{x / 20}}{{10}^{( x + \frac{step}{2} ) / 20} - {10}^{x / 20}} ] \qquad ( 1 )$$

By using EQN. 1, a SNR that is greater than or equal to a maximum SMR in a frame may be calculated using EQN. 2 (SNR≧max_SMR).

$$20 {log}_{10} [ \frac{{10}^{x / 20}}{{10}^{( x + \frac{step}{2} ) / 20} - {10}^{x / 20}} ] \geq max\_SMR \qquad ( 2 )$$

In operation 330, in order to calculate the minimum value of the SNR that satisfies EQN. 2, the maximum quantization step value that satisfies EQN. 2 may be calculated using EQN. 3.

$$step \leq 40 {log}_{10} ( 1 + {10}^{- \frac{max\_SMR}{20}} ) dB \qquad ( 3 )$$

The SNR decreases as the quantization step increases and thus the maximum quantization step value may be calculated using EQN. 3.

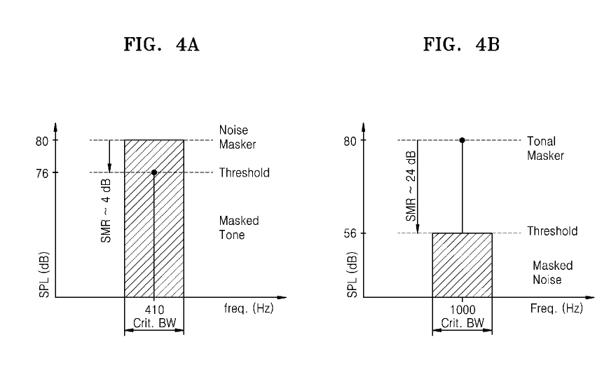

FIGS. 4A and 4B are graphs for describing masking thresholds of tone and noise components of an audio signal, according to an embodiment of the present invention.

In a method of determining a quantization step, according to an embodiment of the present invention, a SMR may be used as a first ratio value indicating an intensity of an input audio signal with respect to a masking threshold. The SMR of the audio signal may be calculated by calculating masking thresholds of tone and noise components of the audio signal, as respectively illustrated in FIGS. 4A and 4B, and assigning weights to the calculated masking thresholds. That is, a noise masking tone (NMT) ratio and a tone-masking-noise (TMN) ratio are used. Generally, the SMR of the noise component is represented to be approximately 4 dB as illustrated in FIG. 4A and the SMR of the tone component is represented to be approximately 24 dB as illustrated in FIG. 4B.

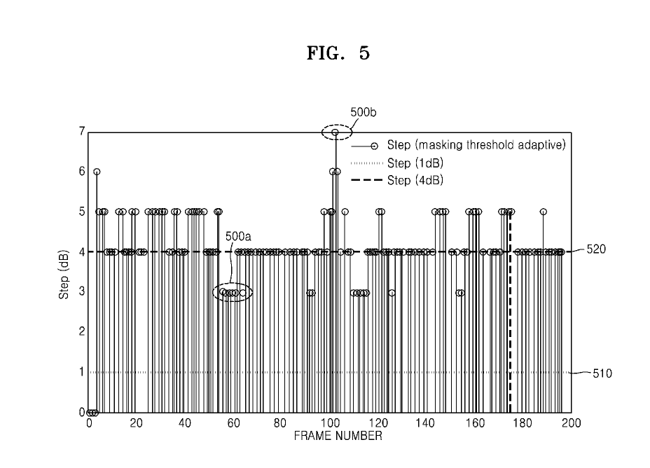

FIG. 5 is a graph for describing an adaptive quantization step that is temporally variable, according to an embodiment of the present invention.

Referring to FIG. 5, the graph includes three plot lines. In this regard, dotted lines indicated by reference numerals 510 and 520 respectively represent cases when fixed quantization steps of 1 dB and 4 dB are used and a variable line with small circles represents a case when an adaptive quantization step according to the current embodiment of the present invention is used.

That is, if the fixed quantization steps of 1 dB and 4 dB as illustrated by the reference numerals 510 and 520 are used, fixed quantization steps are always maintained in entire frames. However, the adaptive quantization step according to the current embodiment of the present invention may vary to, for example, 3 dB or 7 dB for each frame. In more detail, when an adaptive quantization step is used, by adaptively determining a quantization step according to the method described above with reference to FIG. 3, the quantization step varies according to a temporally variable SMR.

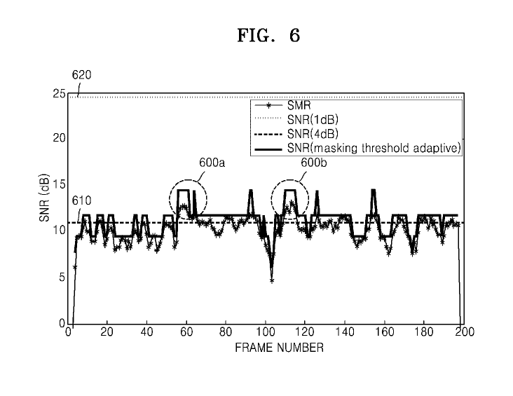

FIG. 6 is a graph for describing correlations between a SNR and a SMR that is temporally variable, when an adaptive quantization step is applied, according to an embodiment of the present invention.

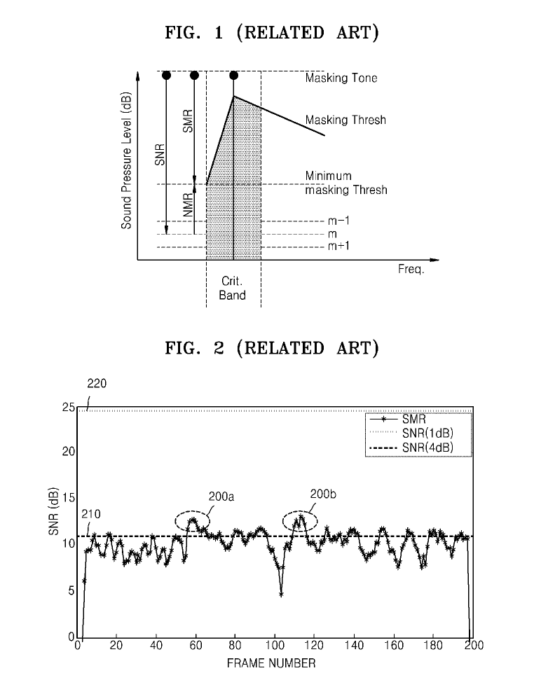

Referring to FIG. 6, when an audio signal is represented in temporal frames, values of the SMR temporally vary as described above with reference to FIG. 2. In this case, a SNR 610 and a SNR 620 to which fixed quantization steps of 4 dB and 1 dB are respectively applied, and an adaptive SNR indicated by a thick line to which the adaptive quantization step is applied are illustrated in FIG. 6.

If the fixed quantization step of 1 dB is applied to the SNR 620, values of the SNR 620 are always greater than the values of the temporally variable SMR indicated by an irregular line with asterisks in entire frames and thus quantization noise is removed. However, relative bit-rates increase. That is, relatively large SNR margins corresponding to differences between the SNR 620 and the temporally variable SMR are generated and thus bits are unnecessarily wasted.

Meanwhile, if the fixed quantization step of 4 dB is applied to the SNR 610 of, values of the SNR 610 are sometimes greater and sometimes less than the values of the SMR. For example, a SNR lack phenomenon occurs in circular regions 600a and 600b, illustrated by dotted lines in FIG. 6, because values of the SNR 610 are less than the values of the SMR. In this case, the quantization noise may not be sufficiently removed.

However, if an adaptive quantization step is used, values of the adaptive SNR are greater than the values of the SMR even in the circular regions 600a and 600b and thus the quantization noise may be removed. Furthermore, the values of the adaptive SNR are much less than the values of the SNR 620 of 1 dB, thereby reducing the bit-rates.

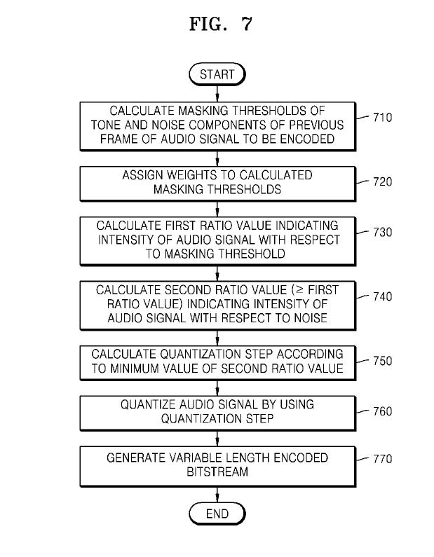

FIG. 7 is a flowchart illustrating a method of encoding an audio signal by using a quantization step adaptively determined according to a masking effect in a psychoacoustics model, according to an embodiment of the present invention.

Referring to FIG. 7, masking thresholds of tone and noise components of a previous frame of the audio signal to be encoded are calculated in operation 710.

Then, weights are assigned to the calculated masking thresholds in operation 720.

Accordingly, a first ratio value indicating an intensity of the audio signal with respect to a masking threshold is calculated in operation 730.

The maximum value of the quantization step in a range in which noise generated when the audio signal is quantized, is masked, is determined according to the first ratio value. The determining of the maximum quantization step may be performed by calculating a second ratio value which is greater than or equal to the first ratio value and indicates an intensity of the input audio signal with respect to the noise in operation 740 and calculating the maximum quantization step according to the minimum value of the second ratio value in operation 750.

The audio signal is quantized by using the determined maximum quantization step in operation 760.

A variable length encoded bitstream is generated by using the quantized audio signal in operation 770.

When the audio signal is quantized, the quantization step calculated as described above is used instead of a fixed quantization step.

When the first ratio value such as a SMR is calculated in order to determine the quantization step, the SMR is calculated by using a TMN (n−1) ratio and an NMT (n−1) ratio of a previous frame (n−1) instead of a current frame n. The previous frame (n−1) is used when the audio signal is encoded because a decoding unit has to use a previously decoded frame (n−1) when the decoding unit calculates the SMR in order to determine a dequantization step.

If the current frame n is the first frame, the previous frame (n−1) does not exist. Accordingly, a predetermined and fixed value, for example 3 dB, may be used as the determined quantization step.

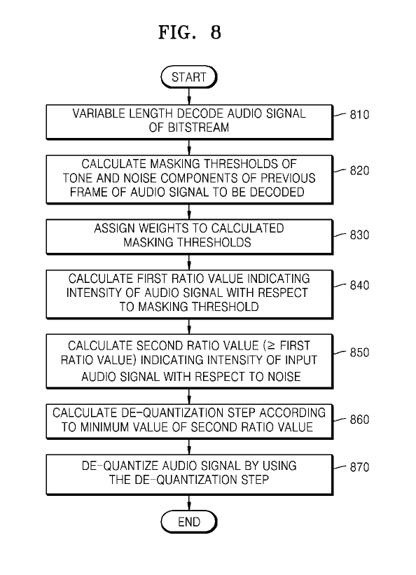

FIG. 8 is a flowchart illustrating a method of decoding an audio signal by using a dequantization step adaptively determined according to a masking effect in a psychoacoustics model, according to an embodiment of the present invention.

Referring to FIG. 8, the audio signal input in the form of a bitstream is variable length decoded in operation 810.

Masking thresholds of tone and noise components of a previous frame (n−1) of the audio signal to be decoded are calculated in operation 820.

Then, weights are assigned to the calculated masking thresholds in operation 830.

Accordingly, a first ratio value indicating an intensity of the variable length decoded audio signal with respect to a masking threshold is calculated in operation 840.

The maximum value of the dequantization step in a range in which noise generated when the audio signal is quantized, is masked, is determined according to the first ratio value. The determining of the maximum dequantization step may be performed by calculating a second ratio value which is greater than or equal to the first ratio value and indicates an intensity of the input audio signal with respect to the noise in operation 850 and calculating the maximum dequantization step according to the minimum value of the second ratio value in operation 860.

The audio signal is dequantized by using the determined maximum dequantization step in operation 870.

If a current frame n is the first frame, the previous frame (n−1) does not exist. Accordingly, a predetermined and fixed value, for example 3 dB, may be used as the determined dequantization step, according to an embodiment of the present invention.

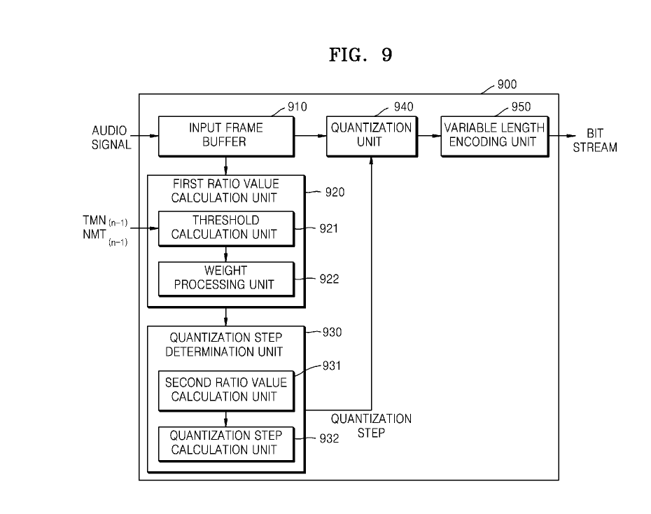

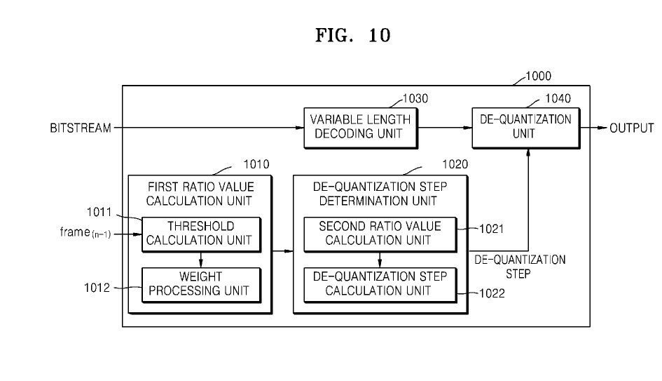

FIG. 9 is a block diagram of an apparatus 900 for encoding an audio signal by using a quantization step adaptively determined according to a masking effect in a psychoacoustics model, according to an embodiment of the present invention.

Referring to FIG. 9, the apparatus 900 according to the current embodiment of the present invention includes a input frame buffer 910, a first ratio value calculation unit 920 for calculating a first ratio value indicating an intensity of the audio signal with respect to a masking threshold, a quantization step determination unit 930 for determining the maximum value of the quantization step in a range in which noise generated when the audio signal is quantized, is masked, according to the first ratio value, a quantization unit 940 for quantizing the audio signal by using the determined maximum quantization step, and a variable length encoding unit 950 for generating a variable length encoded bitstream by using the quantized audio signal.

The first ratio value calculation unit 920 may include a threshold calculation unit 921 for calculating masking thresholds of tone and noise components of a previous frame (n−1) of the audio signal to be encoded, and a weight processing unit 922 for assigning weights to the calculated masking thresholds.

The quantization step determination unit 930 may include a second ratio value calculation unit 931 for calculating a second ratio value which is greater than or equal to the first ratio value and indicates an intensity of the input audio signal with respect to the noise, and a quantization step calculation unit 932 for calculating the maximum quantization step according to the minimum value of the second ratio value. The quantization step determination unit 930 transfers the determined maximum quantization step to the quantization unit 940.

When the first ratio value calculation unit 920 calculates the first rate value such as a SMR, the SMR is calculated by using a TMN (n−1) ratio and an NMT (n−1) ratio of a previous frame (n−1) instead of a current frame n. The previous frame (n−1) is used because a decoding unit has to use a previously decoded frame (n−1) when the decoding unit calculates the SMR.

If the current frame n is the first frame, the previous frame (n−1) does not exist. Accordingly, the quantization unit 940 may use a predetermined and fixed value, for example 3 dB, as the determined quantization step.

FIG. 10 is a block diagram of an apparatus 1000 for decoding an audio signal by using a dequantization step adaptively determined according to a masking effect in a psychoacoustics model, according to an embodiment of the present invention.

Referring to FIG. 10, the apparatus 1000 according to the current embodiment of the present invention includes a variable length decoding unit 1030 for variable length decoding the audio signal input in the form of a bitstream, a first ratio value calculation unit 1010 for calculating a first ratio value indicating an intensity of the variable length decoded audio signal with respect to a masking threshold, a dequantization step determination unit 1020 for determining the maximum value of the dequantization step in a range in which noise generated when the audio signal is quantized, is masked, according to the first ratio value, and a dequantization unit 1040 for dequantizing the audio signal by using the determined maximum dequantization step.

The first ratio value calculation unit 1010 may include a threshold calculation unit 1011 for calculating masking thresholds of tone and noise components of a previous frame (n−1) of the audio signal to be decoded, and a weight processing unit 1012 for assigning weights to the calculated masking thresholds. If a current frame n is the first frame, the previous frame (n−1) does not exist. Accordingly, the dequantization unit 1040 may use a predetermined and fixed value, for example 3 dB, as the determined maximum dequantization step.

Meanwhile, the dequantization step determination unit 1020 may include a second ratio value calculation unit 1021 for calculating a second ratio value which is greater than or equal to the first ratio value and indicates an intensity of the input audio signal with respect to the noise, and a dequantization step calculation unit 1022 for calculating the maximum dequantization step according to the minimum value of the second ratio value. The dequantization step determination unit 1020 transfers the determined maximum dequantization step to the dequantization unit 1040.

Meanwhile, embodiments of the present invention can be written as computer programs and can be implemented in general-use digital computers that execute the programs using a computer readable recording medium.

Also, the data structure used in the embodiments of the present invention described above can be recorded on a computer readable recording medium via various means.

Examples of the computer readable recording medium include magnetic storage media (e.g., ROM, floppy disks, hard disks, etc.), and optical recording media (e.g., CD-ROMs, or DVDs). In another exemplary embodiment, the computer readable recording medium may include storage media such as carrier waves (e.g., transmission through the Internet).

As described above, according to the present invention, quantization noise may be removed and the number of bits required to encode an audio signal may be reduced, by using auditory characteristics of humans.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of adaptively determining a quantization step according to a masking effect in a psychoacoustics model, the method comprising:
calculating a first ratio value indicating an intensity of an input audio signal with respect to a masking threshold; and
determining a maximum value of the quantization step in a range in which noise generated when the audio signal is quantized, is masked, according to the first ratio value.

2. The method of claim 1, wherein the determining of the maximum value of the quantization step comprises:
calculating a second ratio value which is greater than or equal to the first ratio value and indicates an intensity of the input audio signal with respect to the noise; and
calculating the maximum value of the quantization step value according to a minimum value of the second ratio value.

3. The method of claim 2, wherein the second ratio value decreases as the quantization step increases.

4. The method of claim 3, wherein the quantization step is represented by a common logarithm comprising the first ratio value as an exponent.

5. The method of claim 4, wherein the calculating of the first ratio value comprises:
calculating a masking threshold of a tone component and a masking threshold of a noise component of the audio signal; and
assigning weights to the calculated masking thresholds of the tone and the noise components.

6. A method of encoding an audio signal based on a quantization step adaptively determined according to a masking effect in a psychoacoustics model, the method comprising:
calculating a first ratio value indicating an intensity of the audio signal with respect to a masking threshold;
determining a maximum value of the quantization step in a range in which noise generated when the audio signal is quantized, is masked, according to the first ratio value;
quantizing the audio signal based on the determined maximum value of the quantization step; and
generating a variable length encoded bitstream based on the quantized audio signal.

7. The method of claim 6, wherein the calculating of the first ratio value comprises:
calculating a masking threshold of a tone component and a masking threshold of a noise component of a previous frame of the audio signal to be encoded; and
assigning weights to the calculated masking thresholds of the tone and the noise components.

8. The method of claim 7, wherein the determining of the maximum value of the quantization step comprises:
calculating a second ratio value which is greater than or equal to the first ratio value and indicates an intensity of the input audio signal with respect to the noise; and
calculating the maximum value of the quantization step according to a minimum value of the second ratio value.

9. The method of claim 8, wherein the second ratio value decreases as the quantization step increases.

10. The method of claim 9, wherein the quantization step is represented by a common logarithm comprising the first ratio value as an exponent.

11. A method of decoding an audio signal based on a dequantization step adaptively determined according to a masking effect in a psychoacoustics model, the method comprising:
variable length decoding the audio signal input in a form of a bitstream;
calculating a first ratio value indicating an intensity of the variable length decoded audio signal with respect to a masking threshold;
determining a maximum value of the dequantization step in a range in which noise generated when the audio signal is quantized, is masked, according to the first ratio value; and
dequantizing the audio signal based on the determined maximum value of the dequantization step.

12. The method of claim 11, wherein the calculating of the first ratio value comprises:
calculating a masking threshold of a tone component and a masking threshold of a noise component of a previous frame of the audio signal to be decoded; and
assigning weights to the calculated masking thresholds of the tone and the noise components.

13. The method of claim 12, wherein the determining of the maximum value of the dequantization step comprises:
calculating a second ratio value which is greater than or equal to the first ratio value and indicates an intensity of the input audio signal with respect to the noise; and
calculating the maximum value of the dequantization step according to a minimum value of the second ratio value.

14. The method of claim 13, wherein the second ratio value decreases as the dequantization step increases.

15. The method of claim 14, wherein the dequantization step is represented by a common logarithm comprising the first ratio value as an exponent.

16. An apparatus for encoding an audio signal based on a quantization step adaptively determined according to a masking effect in a psychoacoustics model, the apparatus comprising:
a first ratio value calculation unit which calculates a first ratio value indicating an intensity of the audio signal with respect to a masking threshold;
a quantization step determination unit which determines a maximum value of the quantization step in a range in which noise generated when the audio signal is quantized, is masked, according to the first ratio value;
a quantization unit which quantizes the audio signal based on the determined maximum value of the quantization step; and
a variable length encoding unit which generates a variable length encoded bitstream based on the quantized audio signal.

17. The apparatus of claim 16, wherein the first ratio value calculation unit comprises:
a threshold calculation unit which calculates a masking threshold of a tone component and a masking threshold of a noise component of a previous frame of the audio signal to be encoded; and
a weight processing unit which assigns weights to the calculated masking thresholds of the tone and the noise components, and
wherein the quantization step determination unit comprises:
a second ratio value calculation unit which calculates a second ratio value which is greater than or equal to the first ratio value and indicates an intensity of the input audio signal with respect to the noise; and
a quantization step calculation unit which calculates a maximum value of the quantization step according to a minimum value of the second ratio value.

18. An apparatus for decoding an audio signal based on a dequantization step adaptively determined according to a masking effect in a psychoacoustics model, the apparatus comprising:
a variable length decoding unit which variable length decodes the audio signal input in a form of a bitstream;
a first ratio value calculation unit which calculates a first ratio value indicating an intensity of the variable length decoded audio signal with respect to a masking threshold;
a dequantization step determination unit which determines a maximum value of the dequantization step in a range in which noise generated when the audio signal is quantized, is masked, according to the first ratio value; and
a dequantization unit which dequantizes the audio signal based on the determined maximum value of the dequantization step.

19. The apparatus of claim 18, wherein the first ratio value calculation unit comprises:
a threshold calculation unit which calculates a masking threshold of a tone component and a masking threshold of a noise component of a previous frame of the audio signal to be decoded; and
a weight processing unit which assigns weights to the calculated masking thresholds of the tone and the noise components, and
wherein the dequantization step determination unit comprises:
a second ratio value calculation unit which calculates a second ratio value which is greater than or equal to the first ratio value and indicates an intensity of the input audio signal with respect to the noise; and
a dequantization step calculation unit which calculates the maximum value of the dequantization step according to a minimum value of the second ratio value.
